(19) United States
(12) Patent Application Publication
(10) Pub. No.: US 2015/0012445 A1
(43) Pub. Date: Jan. 8, 2015

(54) WEB-BASED AND MOBILE APPLICATION FOR AUTOMATED INSPECTION OF TRUCKS AND TRAILERS

(71) Applicant: CROSSHAIR CONSULTANTS OF NEW YORK, LLC, Greene, NY (US)

(72) Inventor: Roderick W. Reid, Greene, NY (US)

(73) Assignee: CROSSHAIR CONSULTANTS OF NEW YORK, LLC, Greene, NY (US)

(21) Appl. No.: 14/326,101

(22) Filed: Jul. 8, 2014

Related U.S. Application Data
(60) Provisional application No. 61/843,585, filed on Jul. 8, 2013.

(51) Int. Cl. G06Q 10/00; G06Q 30/00; G06Q 50/30

(52) U.S. Cl. CPC G06Q 10/20; G06Q 50/30; G06Q 30/018
USPC 705/305

(57) ABSTRACT

The present invention provides a computer program for assisting in the inspection of a vehicle. The computer program generally includes computer code for permitting a user to select a vehicle from a database of vehicles on which to perform an inspection. A user interface provides a list of maintenance items associated with the selected vehicle, and the user can toggle between and select between satisfactory and unsatisfactory ratings for each of the maintenance items. A data record is created and compiled of the selected ratings for each of the maintenance items. Customized inspection reports can then be generated.

### CROSS-REFERENCE TO RELATED APPLICATIONS

The present application relates to and claims priority to Applicant's U.S. Provisional Patent Application Ser. No. 61/843,585, filed Jul. 8, 2013, the entirety of which is hereby incorporated by reference.

### BACKGROUND

1. Field of Invention

The present invention relates to automated inspection applications and more specifically to applications assisting in inspecting trucks.

2. Description of the Related Art

In order to comply with federal regulations, every truck driver must conduct a pre and post-trip vehicle inspection on the power units utilized for daily operations. This consists of the truck and possibly one or two trailers. Various inspection items that are outlined within federal regulations 49 CFR 392.7 must be visually and manually inspected to ensure these items are in safe working order. This inspection process is tedious and requires detailed documentation. There is presently no way to easily conduct and document the inspection process. Accordingly a need exists in the art for an easy-to-use system to conduct and document the vehicle inspection process in accordance with federal law.

### SUMMARY OF THE INVENTION

In one embodiment, the present invention provides a computer program stored on a non-transitory storage medium for assisting in the inspection of a vehicle. The computer program general comprises computer code for permitting a user to select a vehicle (e.g., a truck and/or a trailer) from a database of vehicles on which to perform an inspection; computer code for providing a user interface that comprises a list of maintenance items associated with the selected vehicle; computer code for providing a user with a means for selecting between satisfactory and unsatisfactory ratings for each of the maintenance items and creating a data record of the selected rating; and computer code for compiling the data record ratings for each of the maintenance items. In one aspect of the invention, the computer program further comprises computer code that provides a user with an option of taking a photograph for each maintenance item selected as unsatisfactory and associating the photograph with the maintenance item. In another aspect of the invention, the computer program further comprises computer code that provides a timer that begins once the user selects a vehicle on which to perform an inspection and that generates a time stamp that is associated with each of the maintenance items. In a further aspect of the invention, the computer program further comprises computer code that permits electronic communication between a user of the computer program and a remote third party. In yet a further aspect of the invention, the computer program further comprises computer code that displays a summary of the satisfactory and unsatisfactory status of the maintenance items entered by the user. In another aspect of the invention, the computer program further comprises computer code for prompting the user to indicate the status of the vehicle as satisfactory to operate or not satisfactory to operate and receiving an electronic signature of the user. In another aspect of the invention, the computer program further comprises computer code for providing the user with a list of previous defects associated with a selected vehicle and the status of each of said previous defects.

In another embodiment, the present invention provides a system for assisting in the inspection of a vehicle. The system generally comprises a server computer capable of providing access to a database comprising a list of terminals and vehicles at each of the terminals stored in memory; a software application stored on a user's computing device adapted to communicate with the server, wherein said software application comprises: computer code for communicating with the database; computer code for permitting a user to select at least one vehicle on which to perform an inspection; computer code for providing a user interface that comprises a list of maintenance items associated with the at least one selected vehicle; computer code for providing a user with a means for selecting between satisfactory and unsatisfactory ratings for each of the maintenance items and creating a data record of the selected rating; and computer code for compiling the data record ratings for each of the maintenance items.

In another embodiment, the present invention provides a method for creating a digital record of a vehicle inspection with the use of a computer program stored on a non-transitory storage medium. The method generally comprises the steps of selecting a vehicle from a list of potential vehicles on which to perform the inspection; providing a user interface that comprises a list of maintenance items associated with the selected vehicle; selecting between satisfactory and unsatisfactory ratings for each of the maintenance items and creating a data record of the selected rating; and compiling the data record ratings for each of the maintenance items.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a high level process flow for conducting inspection of the vehicle;

FIG. 2 shows a case level diagram of an embodiment of the present invention.

FIG. 3 is a high level flow chart of an embodiment of the present invention.

FIG. 4 is a screenshot of the login screen of an embodiment of the web-based application.

FIG. 5 is a screenshot of the dashboard of an embodiment of the web-based application.

FIG. 6 is a screenshot of the inspection of a truck in an embodiment of the web-based application.

FIG. 7 is a screenshot of a list of vehicles stored in an embodiment of the web-based application.

FIG. 8 is a screenshot of a list of trailers stored in an embodiment of the web-based application.

FIG. 9 is a screenshot of an inspection of a truck in an embodiment of the web-based application.

FIG. 10 is a screenshot of a splash screen in an embodiment of the mobile application.

FIG. 11 is a screenshot of the login in an embodiment of the mobile application.

FIG. 12 is a screenshot of the main menu in an embodiment of the mobile application.

FIG. 13 is a screenshot of the Espec-History menu in an embodiment of the mobile application.

FIG. 14A is a screenshot of a pre-trip truck and trailer selector in an embodiment of the mobile application.

FIG. 14B is a screenshot of a previous defects report associated with a particular vehicle.

FIG. 14C is a screenshot of a user's ability to toggle between different terminals and view the truck and trailers located at the selected terminals.

FIG. 15 is a screenshot of the odometer entry in an embodiment of the mobile application.

FIG. 16 is a screenshot of a section select in an embodiment of the mobile application.

FIG. 17 is a screenshot of a section select showing progress of inspections of each section in an embodiment of the mobile application.

FIG. 18 is a screenshot of the list of inspection items in an embodiment of the mobile application.

FIG. 19 is a screenshot of the list of inspection items and receiving a message in an embodiment of the mobile application.

FIG. 20A is a screenshot of the list of inspection items and the option to take a picture in an embodiment of the mobile application.

FIG. 20B is a screenshot showing the ability for the user to electronically communicate a defect found during an inspection.

FIG. 21 is a screenshot of the camera in an embodiment of the mobile application.

FIG. 22 is a screenshot of an inspection summary in an embodiment of the mobile application.

FIG. 23 is a screenshot of a trip selector in an embodiment of the mobile application.

FIG. 24 is a screenshot of the chat screen in an embodiment of the mobile application.

FIG. 25 is a screenshot of the espec query in an embodiment of the mobile application.

FIG. 26 is a screenshot of the info screen in an embodiment of the mobile application.

### DETAILED DESCRIPTION OF THE INVENTION

The present invention, according to an embodiment, is a vehicle inspection software program that is available in an application form. The application automates the vehicle inspection process and provides an electronic inspection list that can be shared in real-time with other decision making personnel within an organization. The application could be offered in both native (mobile) applications for iOS, Andriod, Windows, Blackberry, or any other emerging mobile market, as well as an application that may be uploaded directly to a mobile device without being downloaded from a marketplace. The application may also exist as a web based application that could be accessed via an internet browser.

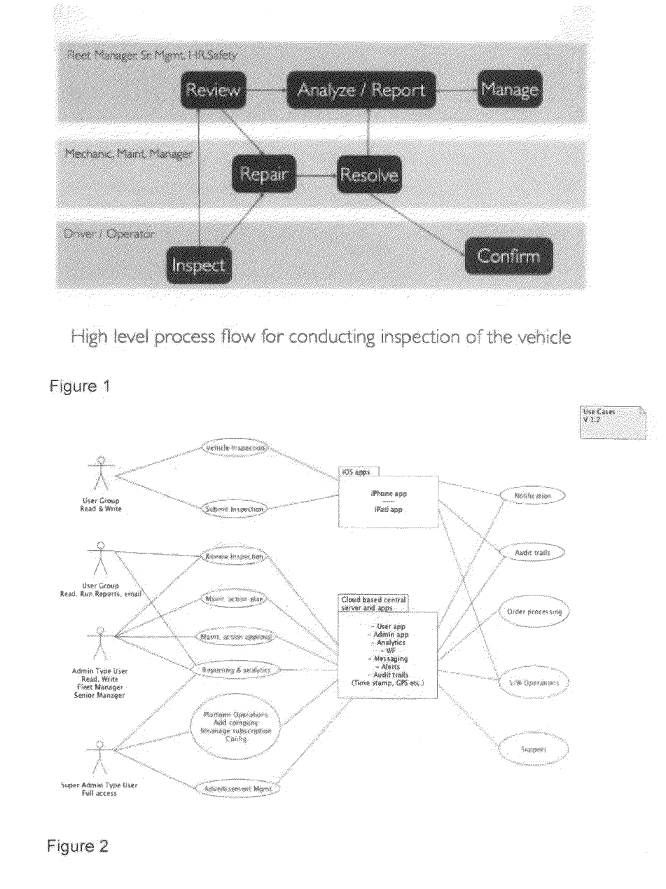

Referring now to the drawings, wherein like reference numerals refer to like parts throughout, there is seen in FIG. 1, a high level process flow for conducting a vehicle inspection. FIG. 1 shows the level of communication and interaction required to properly inspect and repair a fleet of vehicles.

FIG. 2 shows a use case diagram, revealing all parties involved, their respective tasks, how they access the application, what information is generated by the application, and how each element relates to each other.

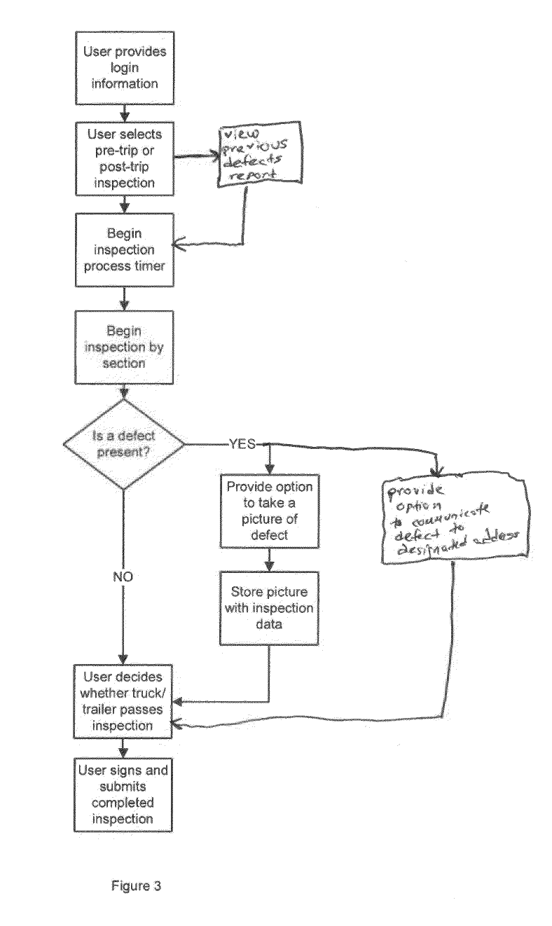

Referring to FIG. 3, the overall system is illustrated. First, the user will login to the application with a unique user PIN and password. Next, the user will then specify whether or not the they are conducting a pre or post-trip vehicle inspection. The user will then select the truck number, and trailer if applicable, which will be pre-programmed on the backend for the user's convenience. Next, the user will be prompted to input that unit's odometer reading. Selecting “Start” will engage a timer to time the entire inspection process. The user inspects the truck and trailer according to a pre-programmed inspection list. If any item on the list fails inspection, the user is provided with the opportunity to take a picture of the item that failed inspection. After the inspection is completed the user may decide whether truck/trailer passed inspection, and may sign the inspection. The inputted data may be stored based on company, truck number, trailer number, and driver. In one embodiment, this data can be made available to administrative accounts within that company. All info may also be stored in a secure data cloud that has various security firewalls to protect clients information.

The front-end user, in this embodiment, also has the ability to view past inspection information for each truck and trailer(s). The front-end user may also ask questions about the power units he or she is inspecting via a query section, which may be configured as a text message or e-mail and be sent to a customizable communication channel for each client. For example, front-end user may ask, “Why brakes weren't fixed on truck 454?” Maintenance personnel can respond: “We're getting rid of that truck, please take truck 455.”

The inspection checklist may be separated by areas of the truck and trailer(s), if applicable, and by the specific items within each area. Each item on the checklist may take the form of a toggle. The user may tap on the identified area specific to each section once to turn the button green, meaning this mechanical item is in satisfactory condition. Tapping on the same button turns the button red which means this mechanical item ‘Needs Repair’. If an item is designated that it ‘Needs Repair’, the option to take a picture of the item and also to add notes is then made available. The picture(s) and notes will be attached to this inspections information. At the end of the inspection the user is reminded by all areas designated ‘Needs Repair’ and is prompted to electronically sign confirming the inspection. After signing the user can then submit this information. Submitted information may be stored in a separate server to aid in auditing processes.

In this embodiment, the inputted data from the user may then be sent to a customizable communication channel within that organization. If defects were found, the appropriate personnel (dispatch, fleet manager, maintenance, owner) can decide what actions are necessary to take. If the mechanical defects warrant immediate action because they pose a potential safety risk, that truck/trailer can then be addressed immediately. This greatly mitigates the risks associated with roadside inspection tickets and accidents.

The application's information may also provide the back end for administrative accounts. For example, mechanics can login into the web-based application (or mobile) and see any issues that may need attention. Mechanics can amend these issues and sign off stating they have either been fixed, or are not in need of fixing and do not pose a safety risk. Users on the backend may also prioritize the maintenance schedule based on the severity of any mechanical issues that have been inputted from the front-end user. The backend may also run reports to illustrate individual data on specific trucks, trailers, and drivers. The application provides times for each inspection, pictures of mechanical defects, and any notes specific to an inspection to the backend for review and analysis.

Backend administrative users may also add vehicles or drivers. The administrative users can sort vehicles into specific groups and add notes such as; VIN, year, make, model, tire size, take picture of the unit, etc. The back end of the application may also serve as a tool by which administrative personnel can manage large fleets of vehicles by providing an up-to-date status report for each vehicle within the fleet.

FIGS. 3-8 show screens of multiple tabs within the web-based application displaying the back end of the application. The web-based application may be separated and provided to the user by navigating through the tabs. The administrative user, through the back end, can edit the units that are being monitored by the application. For example, the administrative user can add truck/trailer which will then update on the front-end, so drivers can input data specific to these units during vehicle inspections. The web-based application also allows for the user to visually see which trucks/trailers have open issues in terms of mechanical deficiencies. Maintenance admin can log in and monitor these issues and fix them and record the process all within the application.

FIG. 3, shows where a user may log into the web-based application. If the user logs through an account pre-configured to bring him to the back end, he will be brought to the back end of the application. Alternatively, he may be brought to the front-end if that is what he has permission to view, or if it is what he elects to do if he has permission to view both.

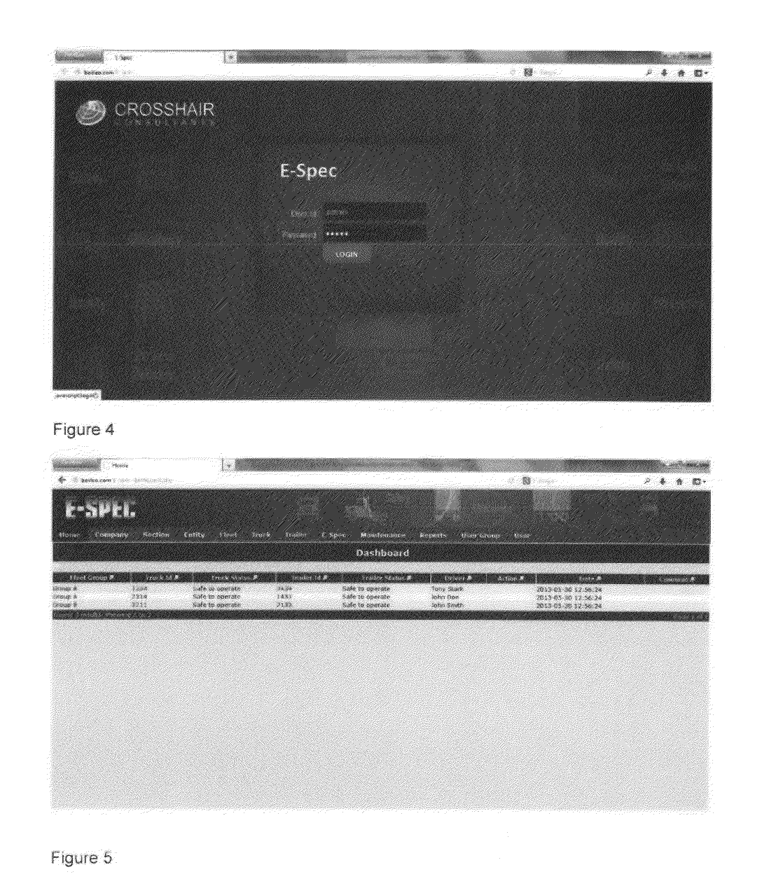

FIG. 4 shows the repair status of several trucks and trailers stored in the application, as well as the date of their inspection, the driver conducting the inspection, their unit number and what fleet they belong to.

FIG. 5 shows a more in-depth view of the repair status of a particular vehicle.

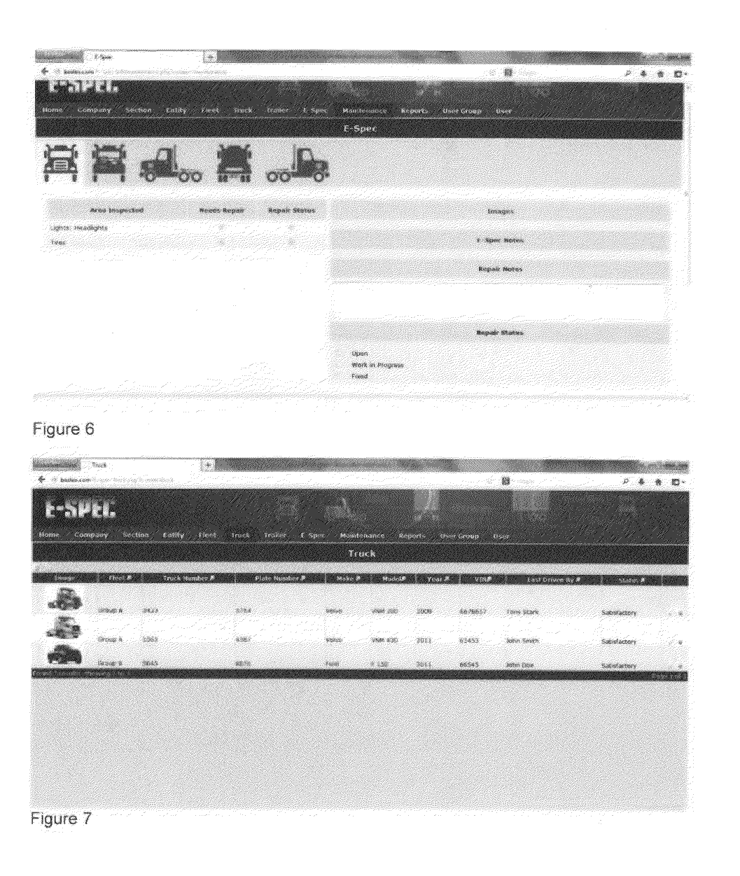

FIG. 6 shows a screen containing the make and model numbers, the vin, the year of manufacture, the tack number, the fleet group, a picture, the driver, and the repair status of the vehicles stored in the application.

FIG. 7 shows a screen containing an image of a trailer, the fleet group, the trailer number, the plate number, the make, the model, the year, the VIN number, the GVWR, the driver, and the repair status of each trailer stored in the application.

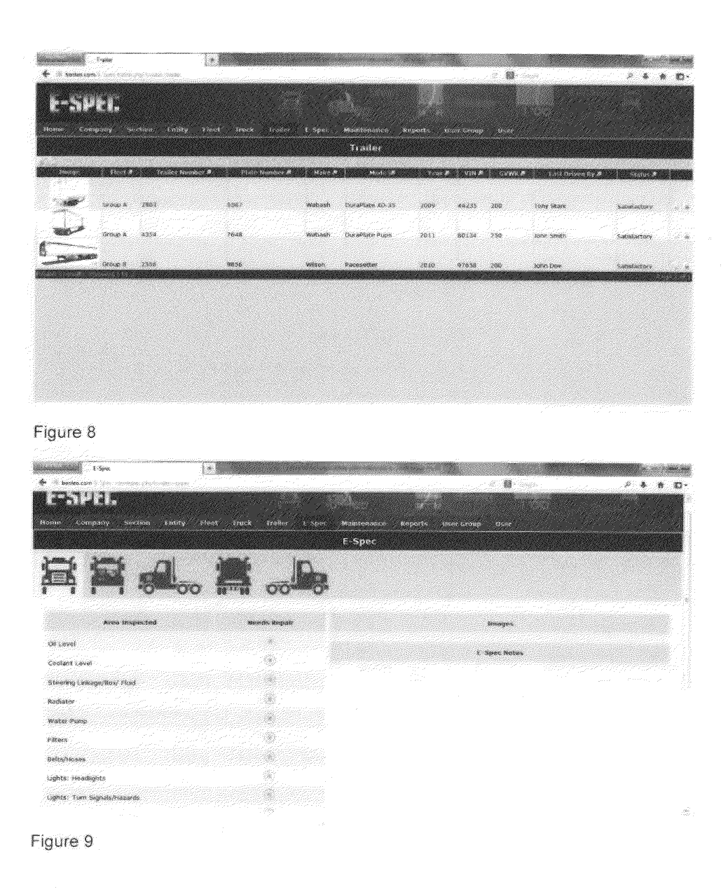

FIG. 8 is another view of the in-depth view of the repair status of a particular vehicle.

The web-based application can also be used to display the front-end of the application, and the mobile application can display the back end.

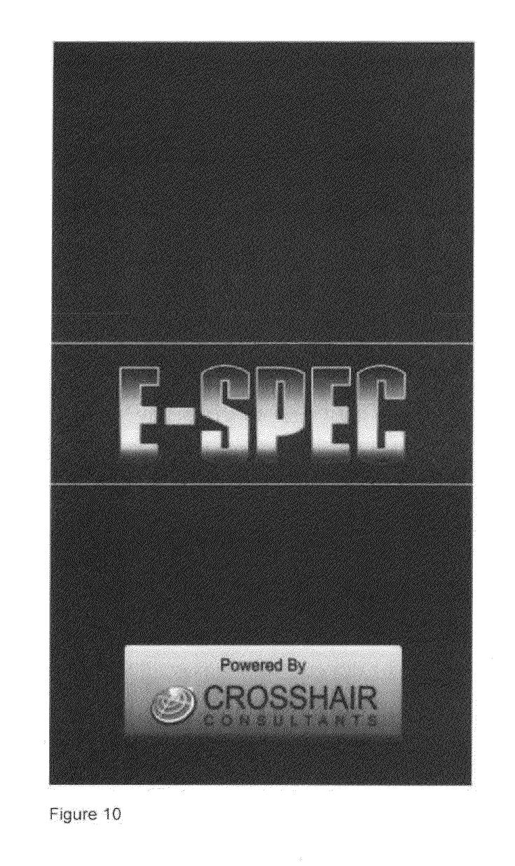

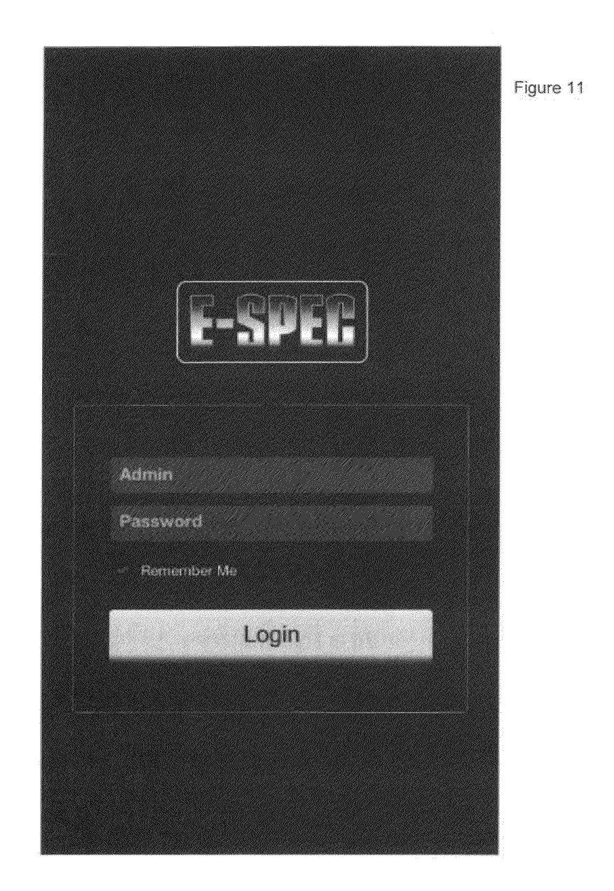

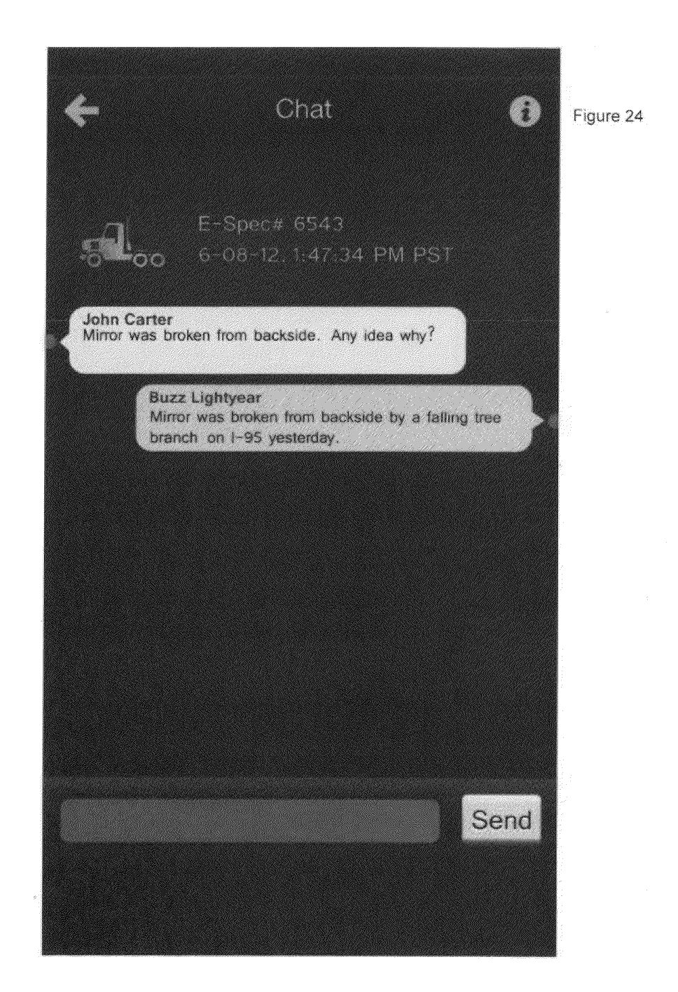

FIGS. 9-23 detail an embodiment of the mobile user interface of the present invention.

During an inspection of truck, trailer, etc. user may physically click on icons to state the status of that sub-section (part). All sub-sections start with an unspecified status and a color of grey. One click changes the status to ‘satisfactory’ and the color to green. Two clicks changes the status to not a ‘defect’ and changes the color to red.

User may also use voice commands utilizing a hands-free option to dictate the status of the sub-sections which will subsequently change the color of the icons to match the voice command. Commands may be customized per client request but standard options include ‘Yes’ or ‘No’ to denote whether that sub-section is satisfactory.

FIG. 10 shows a splash screen that appears once the user selects the application icon from the home screen of the device. The splash screen displays while the application loads.

The next displayed screen, shown in FIG. 11, prompts the user to login using their employee PIN and password. In an alternative embodiment, the application could be secured with facial recognition, fingerprint recognition, or other biometric indicators. Alternatively, the application could log the user in automatically,

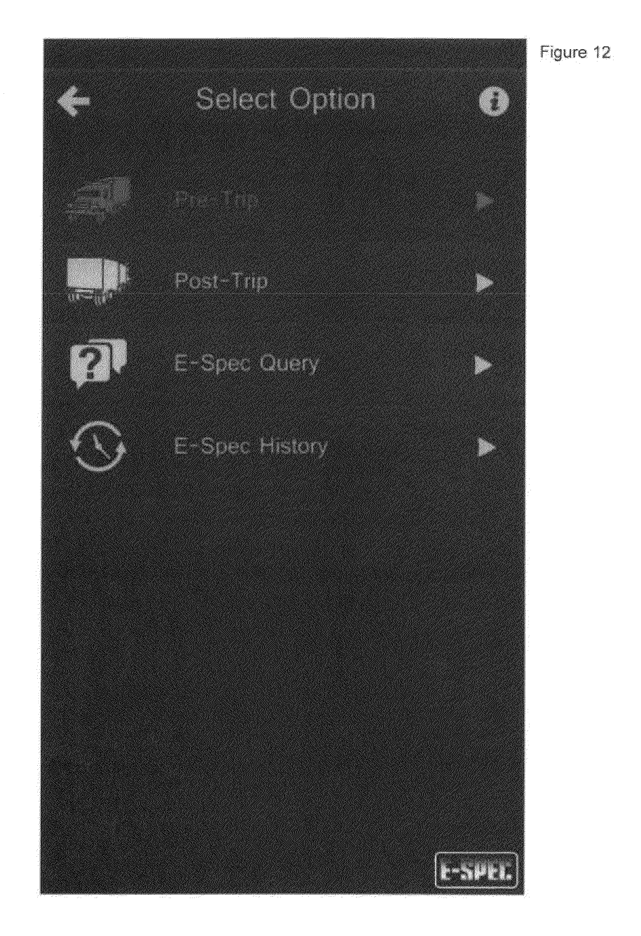

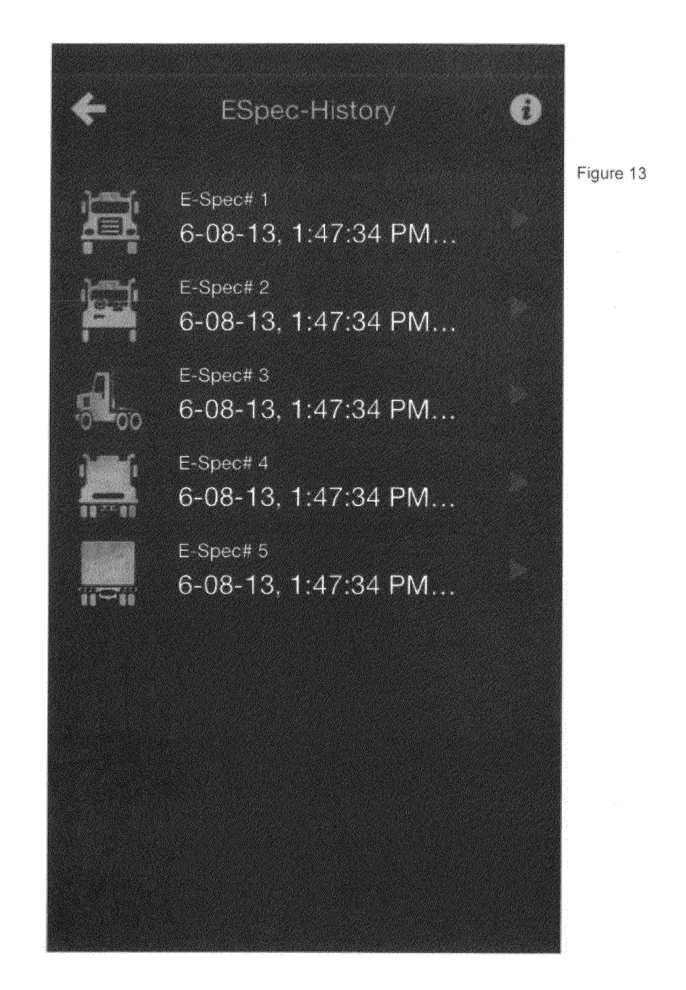

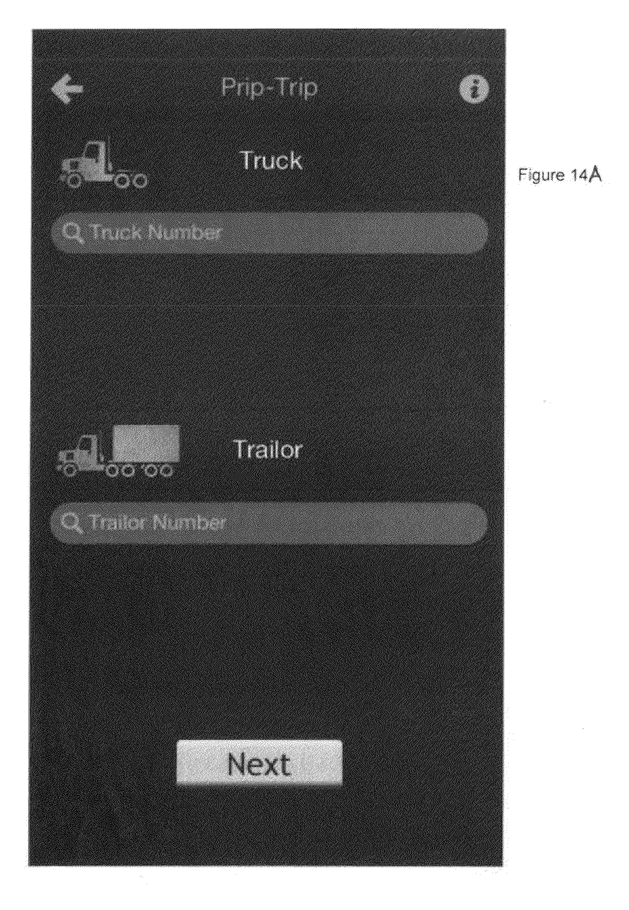

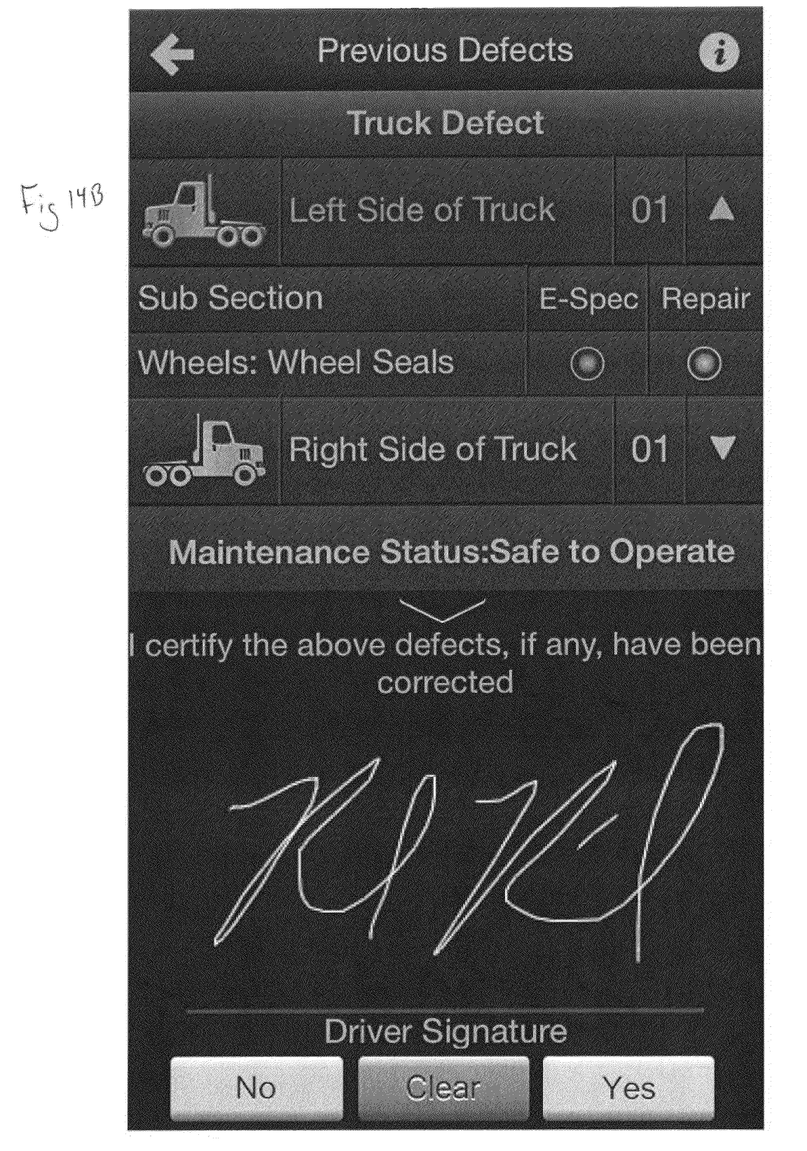

Once the user has entered his or her employee PIN and password the application displays a screen, as shown in FIG. 12, allowing the user to select which type of inspection he or she is conducting—either pre-trip or post-trip—as well as to view the inspection history of each unit or to speak to support personnel.

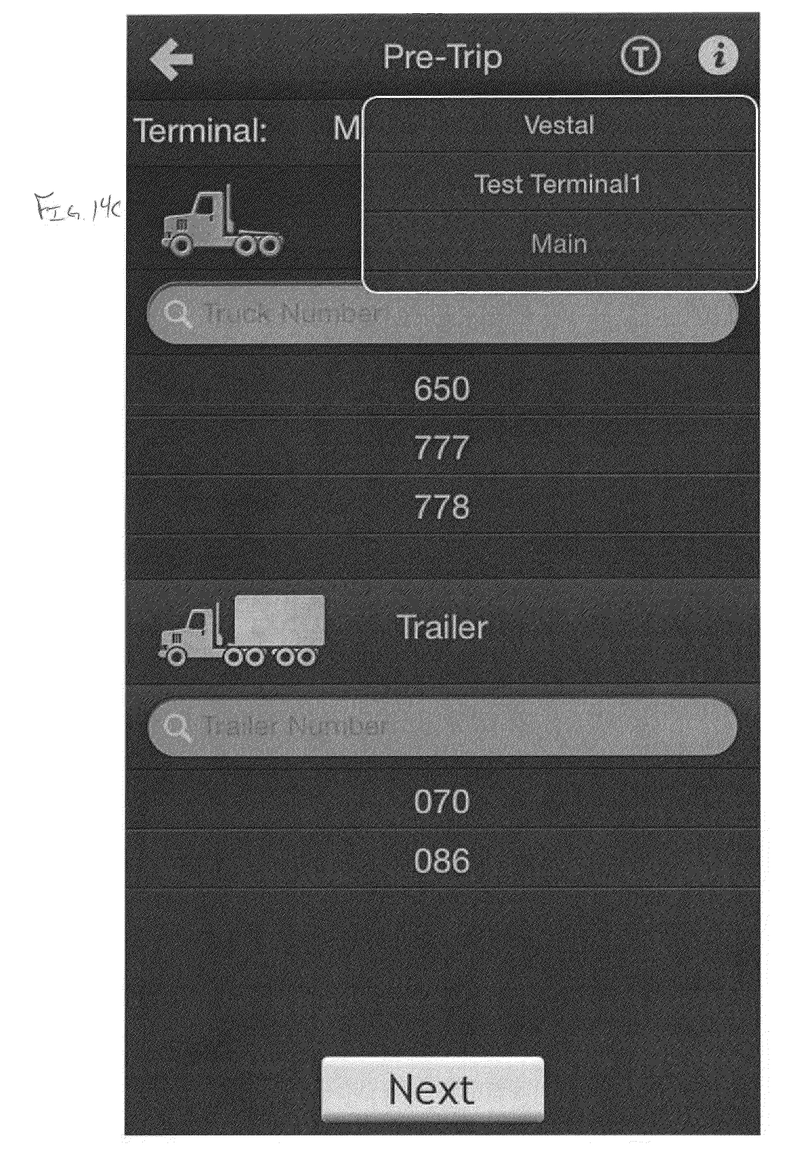

Selecting the inspection history option, shown in FIG. 13 as ‘E-Spec History’, allows the user to look up all previously-entered inspection history for each unit. The user also may request information on these units from support personnel via the ‘E-Spec Query’ option which opens communication channels with maintenance, dispatch, and others.

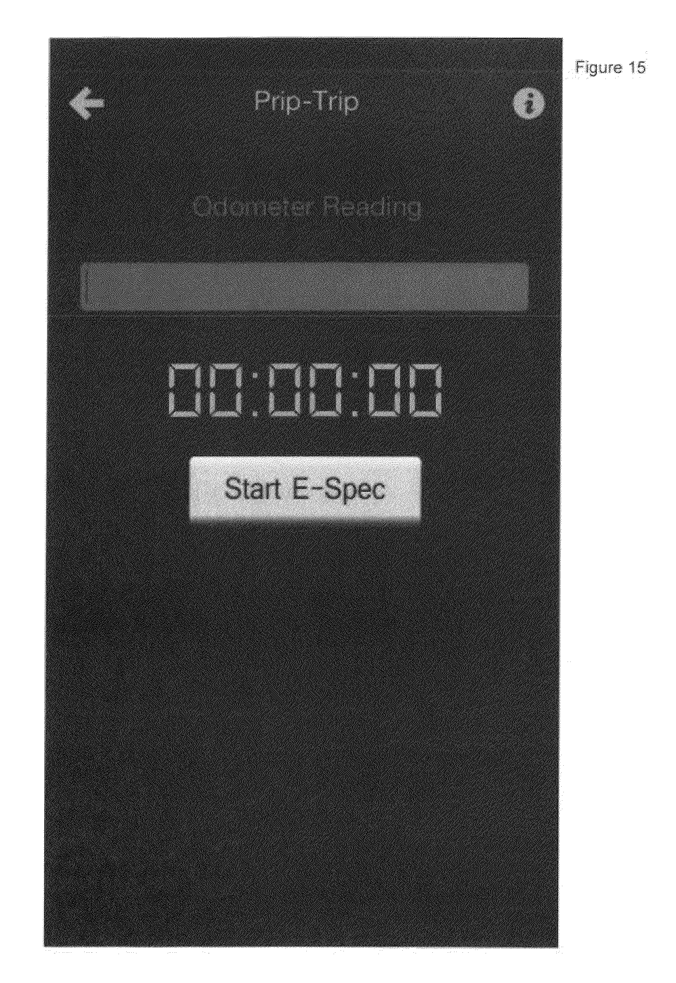

Selecting the Pre-Trip inspection option brings the user to a separate screen, shown in FIG. 14A, requiring the user to select from a drop down list of preloaded numbers the vehicle and trailer that he or she is inspecting. The application may narrow the selectable units according to the preliminary inputted numbers. All information is stored based on driver PIN, truck number, and trailer number in individual files. Once a vehicle is selected, a previous defects report will be called up to let the user know of that vehicle's previous defects and the status as to whether the defects have been repaired and whether the vehicle is safe to use, as shown in FIG. 14B. Additionally, a user, if given access by management via the initial configuration settings (done via a website), can also toggle between different terminals and view the trucks/trailers located at any of the selected terminals, as shown in FIG. 14C.

Once the user selects the appropriate truck and trailer, the inspection process for that truck and trailer begins. As seen in FIG. 15, the first inspection screen requires the user to input the odometer reading for that vehicle. Also seen in the same figure is a clock that runs throughout the inspection process. Each step of the inspection process is marked with a time stamp to show that adequate time was taken to conduct a proper and thorough inspection.

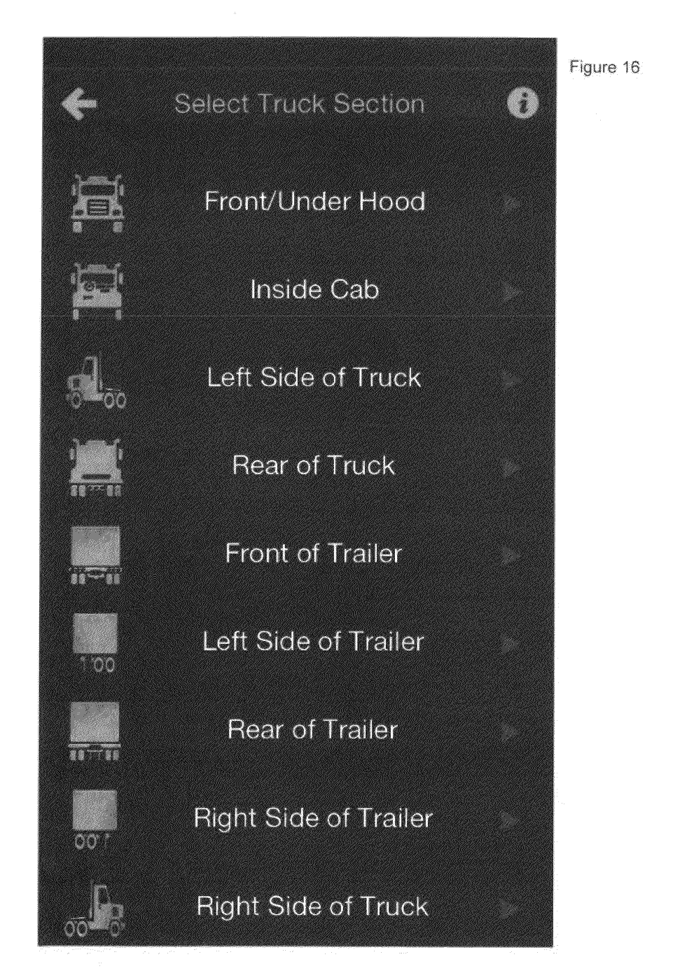

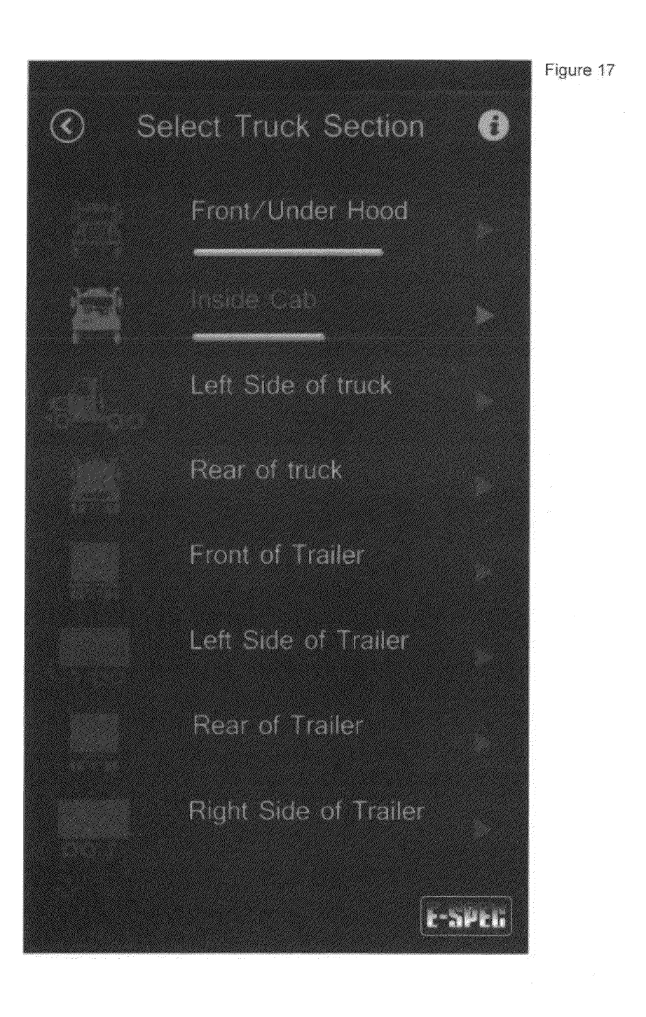

Upon entering the odometer reading, the user is brought to screen, seen in FIG. 16, outlining each section of the truck and trailer that requires inspecting. Each section displayed must be inspected to complete the pre-trip inspection. Each section could display its inspection status and results. For example, displaying a red line under a section could mean that there is a defect that needs repair, as shown in FIG. 17. A green line could mean no defects were found. The length of the line could show the status of the inspection in that section according to percentage, so that incomplete inspections are displayed with a partial line. Progression through the inspection can be done either manually or by voice command.

Selecting a section brings the user to a screen, listing each part of that section to inspect.

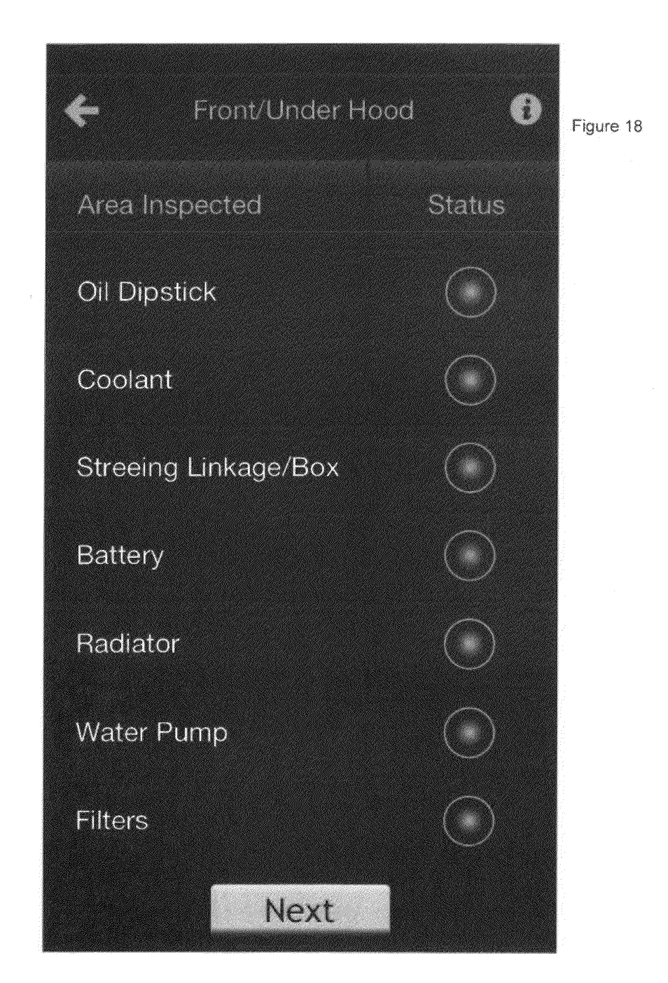

FIG. 18, shows the inspection list required for the section ‘Front/Under Hood.’ This screen is representative of the section inspection lists that would appear for each selectable section. Here we can see that the Oil: Dipstick needs repair based on the users' inspection—as this is indicated in red.

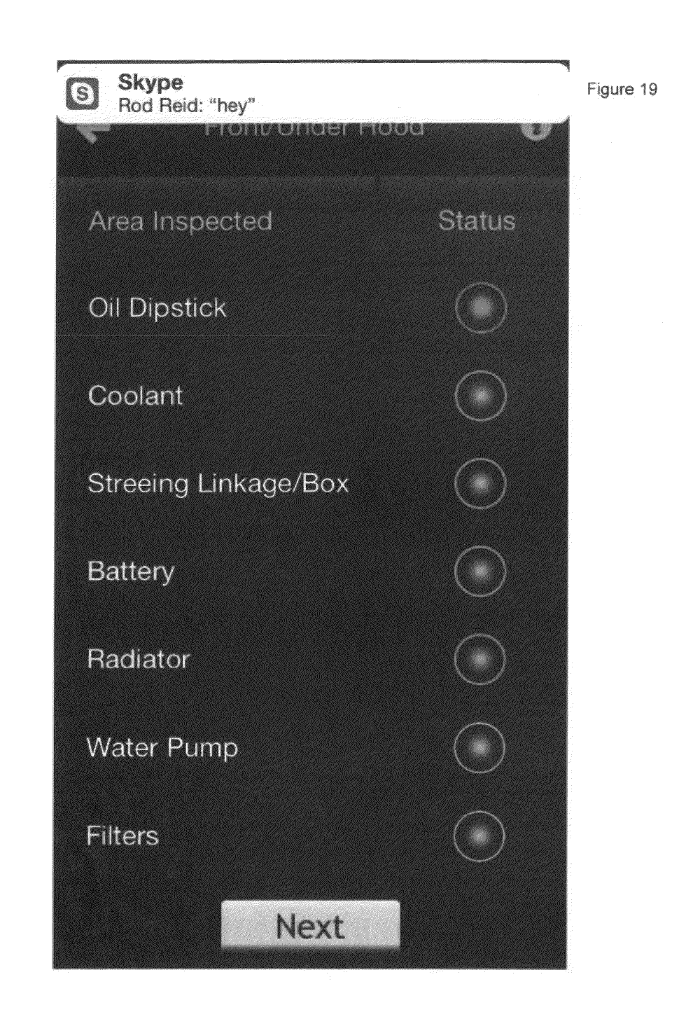

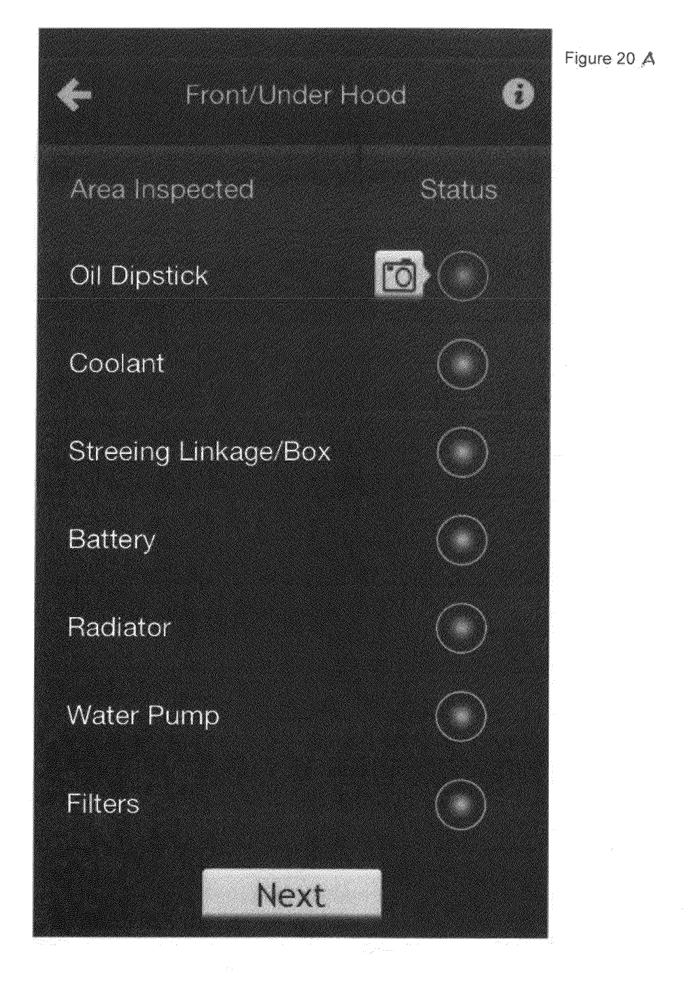

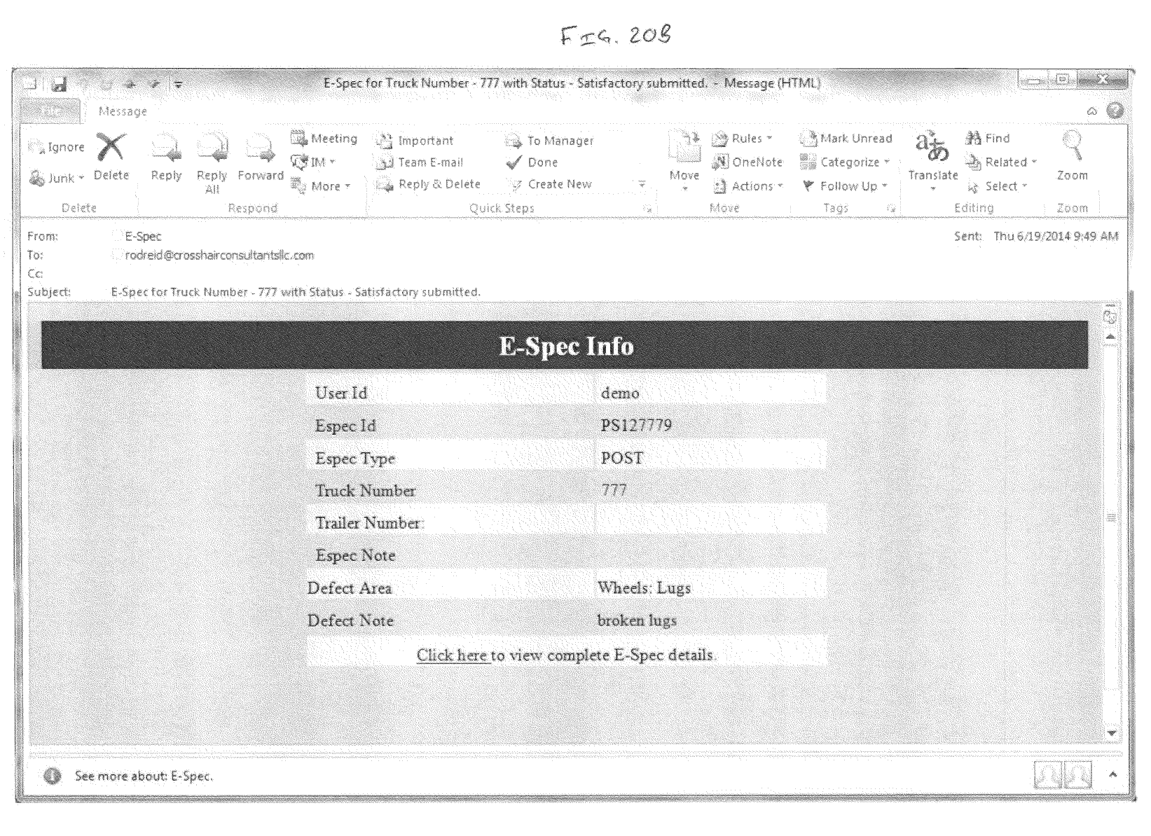

As shown in FIG. 19, a user may communicate at any time with administrative personnel. Administrative personnel may also send messages to user logged onto the application. Incoming messages may be displayed across the top of the screen in a banner format, as shown, or could be configured as pop-ups. The application may incorporate third-party communication applications such as Skype, Gmail, G-chat, or may make use of the mobile applications native to the mobile to device to send messages between font-end and back-end users.

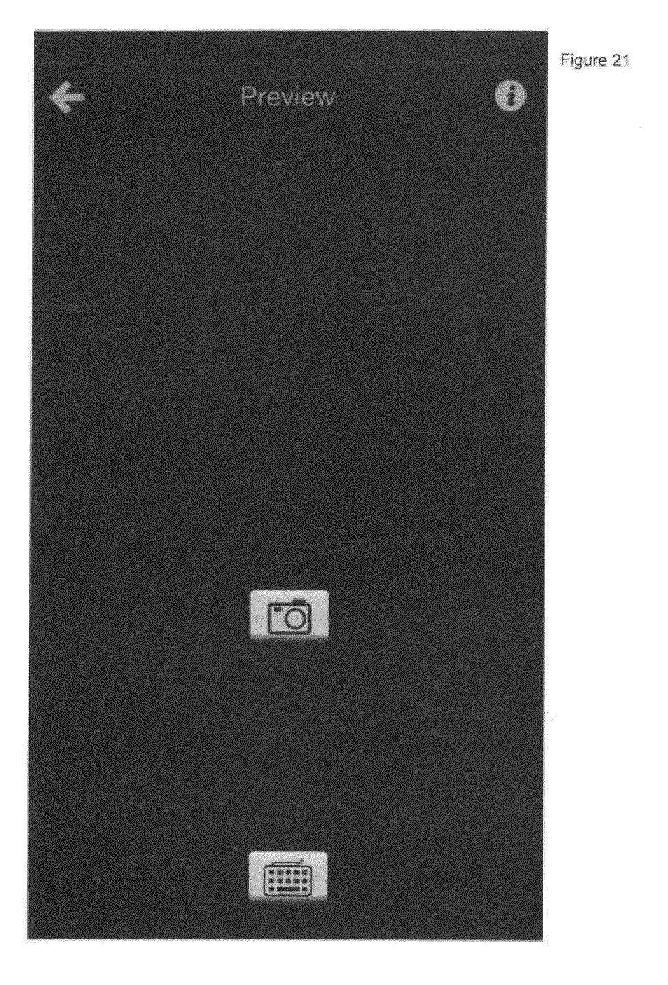

When an item is deemed that it needs repair, the user will have the option to take a picture of the mechanical defect, as shown in FIG. 20A, which will be attached to the inspection data for this vehicle. FIG. 21, shows screen for taking a picture of the defect. In this embodiment, there is a section for notes under the picture. In addition, as shown in FIG. 20B, if a defect is noted during the inspection, a communication link (e.g., an e-mail application) will be available for the user to communicate the defect back to management's designated email address (or other communication address, e.g., social media account, instant message account, etc.).

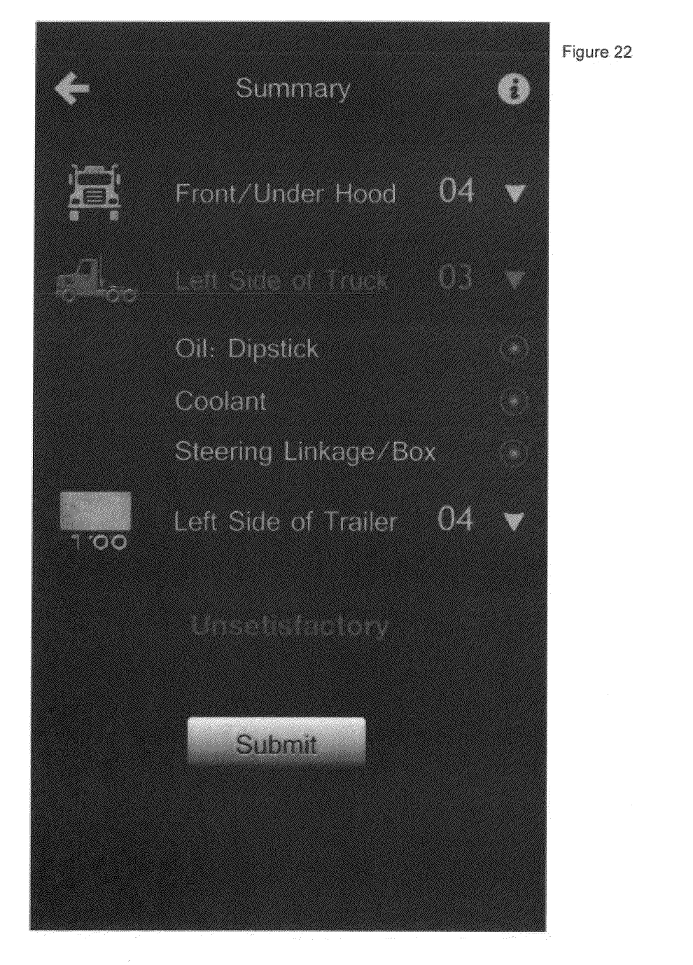

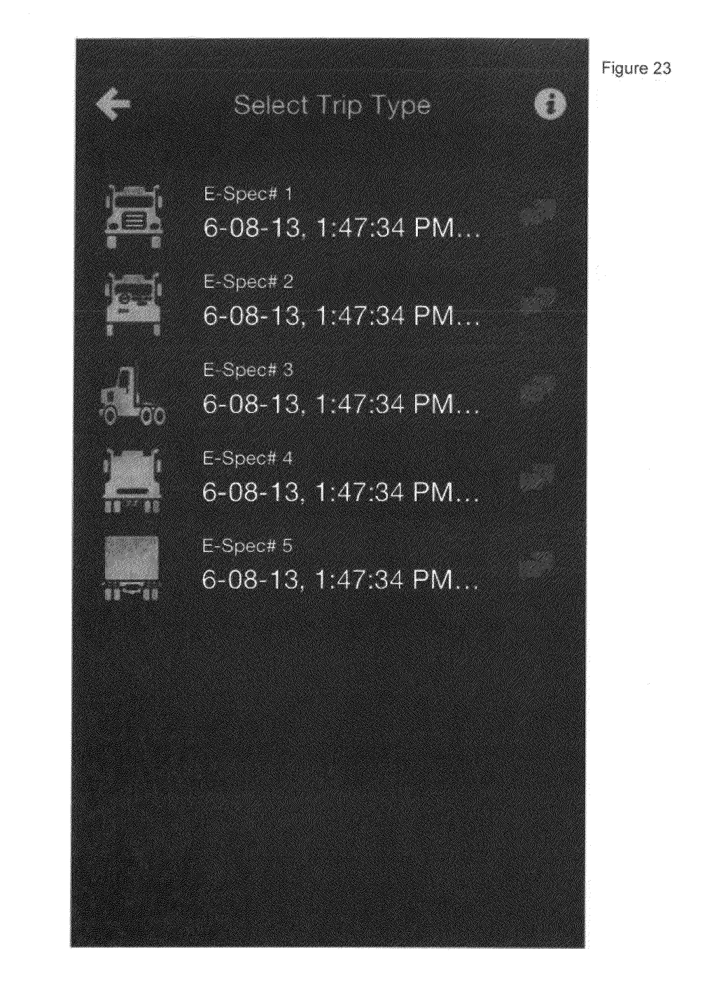

Once the user has completed the inspection process, the application displays summary of the vehicle inspection, as seen in FIG. 22. All areas with defects are noted. These defects may display in the form of a selectable drop down menu under each section title. The driver is prompted to decide the status of the condition of the vehicle: whether it is satisfactory to operate or unsatisfactory to operate. The driver then signs with his finger and submits the data.

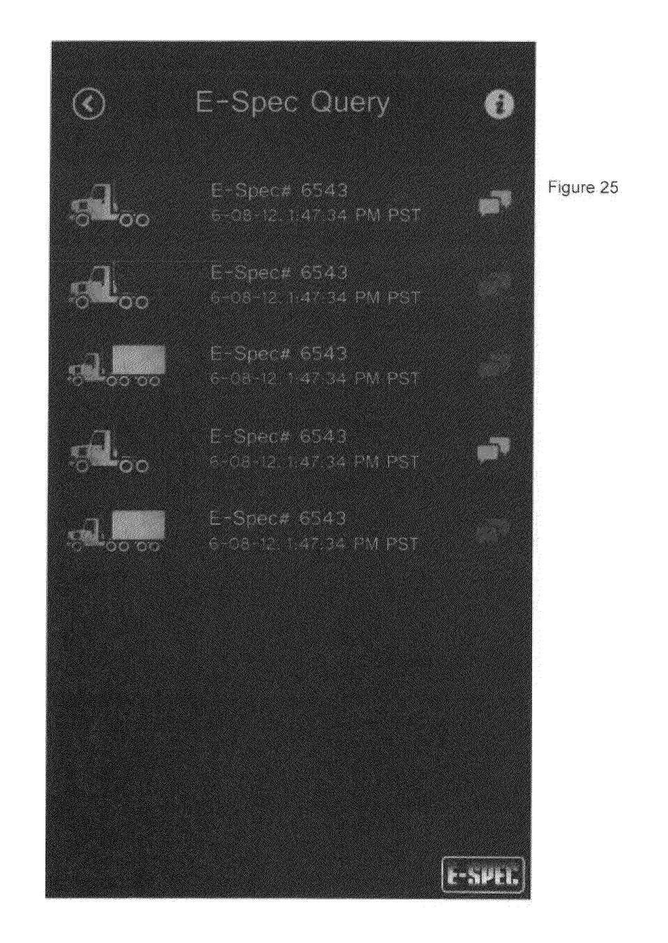

FIG. 25 screen shows the ‘E-Spec Query’ screen in greater detail. E-Spec Query allows to directly ask questions about certain issues concerning certain trucks/trailers with other personnel within the organization. This creates open communication channels within the organization, ensuring that identified problems may be addressed quickly and properly. Selecting a previous inspection from the E-Spec Query screen allows the user to view any previous defects, communicate with the personnel about whether those defects were fixed. FIG. 24 shows an example of a conversation between a user and personnel.

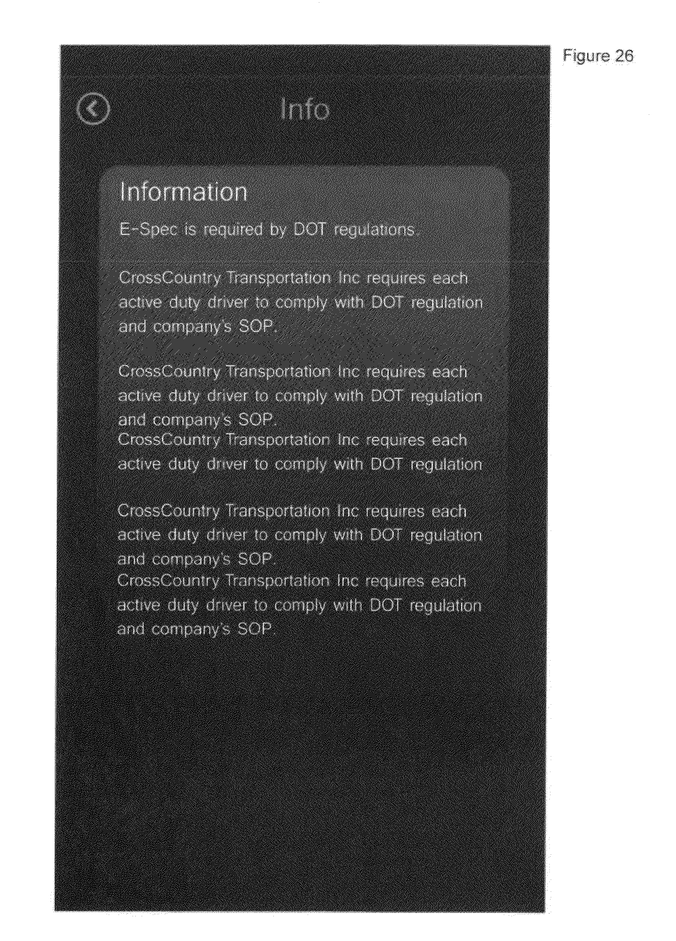

The application may also be configured to show customizable informative text. For example, as shown in FIG. 26, the user clicks on the ‘i’ icon at the top right, the application will display a customizable message. Clients can use this to show specific information—how many tie downs for load securement, specify the process of E-Spec, provide company contact information, etc.

Clients may also customize the order and content of the inspection section. The last option to record the status of the vehicle may also be disabled—some clients prefer their drivers not make this decision.

Once the information is input by the user, the data is sent to customized communication channels. This information is sent to be stored in a cloud data-base that is protected and unique by client account. If defects are identified, the data may be sent to email accounts within that company. This data can be split into various forms to run reports on mechanical areas, trucks, trailers, and driver information. This can be run based on day, month, or year.

What is claimed is:

1. A system for assisting in the inspection of a vehicle, comprising:
a. a server computer capable of accessing a database comprising a list of vehicles stored in memory;
b. a software application stored on a user's computing device adapted to communicate with said server, wherein said software application comprises:
i. computer code for communicating with said database;
ii. computer code for permitting a user to select at least one vehicle on which to perform an inspection;
iii. computer code for providing a user interface that comprises a list of maintenance items associated with said at least one selected vehicle;
iv. computer code for providing a user with a means for selecting between satisfactory and unsatisfactory ratings for each of said maintenance items and creating a data record of said selected rating; and
v. computer code for compiling the data record ratings for each of said maintenance items.

2. The system according to claim 1, wherein said software application further comprises computer code that provides a user with an option of taking a photograph for each maintenance item selected as unsatisfactory and associating said photograph with said maintenance item.

3. The system according to claim 1, wherein said software application further comprises computer code that provides a timer that begins once the user selects a vehicle on which to perform an inspection and that generates a time stamp that is associated with each of said maintenance items.

4. The system according to claim 1, further comprising computer code that permits electronic communication between two remote users of said system while one of said users is using the software application.

5. The system according to claim 1, wherein said software application further comprises computer code that displays a summary of the satisfactory and unsatisfactory status of the maintenance items entered by the user.

6. The system according to claim 5, wherein said software application further comprises computer code for prompting the user to indicate the status of the vehicle as satisfactory to operate r not satisfactory to operate and receiving an electronic signature of the user.

7. The system according to claim 1, wherein said software application further comprises computer code for providing the user with a list of previous defects associated with a selected vehicle and the status of each of said previous defects.

8. A computer program stored on a non-transitory storage medium for assisting in the inspection of a vehicle, comprising:
a. computer code for permitting a user to select a vehicle from a database of vehicles on which to perform an inspection;
b. computer code for providing a user interface that comprises a list of maintenance items associated with said selected vehicle;
c. computer code for providing a user with a means for selecting between satisfactory and unsatisfactory ratings for each of said maintenance items and creating a data record of said selected rating; and
d. computer code for compiling the data record ratings for each of said maintenance items.

9. The computer program according to claim 8 further comprising computer code that provides a user with an option of taking a photograph for each maintenance item selected as unsatisfactory and associating said photograph with said maintenance item.

10. The computer program according to claim 8 further comprising computer code that provides a timer that begins once the user selects a vehicle on which to perform an inspection and that generates a time stamp that is associated with each of said maintenance items.

11. The computer program according to claim 8 further comprising computer code that permits electronic communication between a user of the computer program and a remote third party.

12. The computer program according to claim 8 further comprising computer code that displays a summary of the satisfactory and unsatisfactory status of the maintenance items entered by the user.

13. The computer program according to claim 12 further comprising computer code for prompting the user to indicate the status of the vehicle as satisfactory to operate r not satisfactory to operate and receiving an electronic signature of the user.

14. The computer program according to claim 8 further comprising computer code for providing the user with a list of previous defects associated with a selected vehicle and the status of each of said previous defects.

15. A computer implemented method for creating a digital record of a vehicle inspection with the use of a computer program stored on a non-transitory storage medium, comprising the steps of:
a. selecting a vehicle from a list of potential vehicles on which to perform the inspection;
b. providing a user interface that comprises a list of maintenance items associated with said selected vehicle;
c. selecting between satisfactory and unsatisfactory ratings for each of said maintenance items and creating a data record of said selected rating; and
d. compiling the data record ratings for each of said maintenance items.

16. The method according to claim 15 comprising the further step of providing a user with an option of taking a photograph for each maintenance item selected as unsatisfactory and associating said photograph with said maintenance item.

17. The method according to claim 15 comprising the further step of providing a timer that begins once the user selects a vehicle on which to perform an inspection and that generates a time stamp that is associated with each of said maintenance items.

18. The method according to claim 15 comprising the further step of displaying a summary of the satisfactory and unsatisfactory status of the maintenance items entered by the user.

19. The method according to claim 18 comprising the further step of prompting the user to indicate the status of the vehicle as satisfactory to operate r not satisfactory to operate and receiving an electronic signature of the user.

20. The method according to claim 15 comprising the further step of providing the user with a list of previous defects associated with a selected vehicle and the status of each of said previous defects.
